(19) United States
(12) Patent Application Publication
(10) Pub. No.: US 2026/0220880 A1
(43) Pub. Date: Jul. 30, 2026

(54) COMPUTING SYSTEM WITH DIFFUSION TRANSFORMER MODEL FOR GENERATING MULTI-VIEW IMAGES

(71) Applicant: Bytedance Technology Ltd., Grand Cayman (KY)

(72) Inventors: Peng WANG, Los Angeles, CA (US); Yichun SHI, Los Angeles, CA (US); Seung Wook KIM, Los Angeles, CA (US); Kejie LI, Los Angeles, CA (US)

(21) Appl. No.: 19/415,589

(22) Filed: Dec. 10, 2025

Related U.S. Application Data
(60) Provisional application No. 63/750,150, filed on Jan. 27, 2025.

(51) Int. Cl. G06T 15/20; G06N 3/0455; G06N 3/08; G06T 17/20

(52) U.S. Cl. CPC G06T 15/205; G06N 3/0455; G06N 3/08; G06T 17/20

(57) ABSTRACT

Generating multiple images of an object from different viewpoints is useful to generate 3D objects. The present disclosure describes a text-to-multi-view diffusion model that produces dense and consistent multi-view images of an object, which can be used by 3D reconstruction algorithms to generate 3D objects. For enhanced efficiency, multi-view images are encoded in a spatio-temporally compressed latent space, significantly reducing latency in multi-view generation with a slight performance tradeoff. Effective training of the model was achieved by strategically decomposing training into a plurality of steps. The present systems and methods are believed to outperform existing text-to-multi-view generation methods, in both image quality and multi-view consistency, while benefiting from the efficiency gains of spatio-temporal latents.

### CROSS REFERENCE TO RELATED APPLICATION

This application claims priority to U.S. Provisional Patent Application Ser. No. 63/750,150, filed Jan. 27, 2025, the entirety of which is hereby incorporated herein by reference for all purposes.

### BACKGROUND

Multi-view generation refers to the generation of images of an object from multiple camera views, using generative machine learning algorithms. One use of multi-view images is by three dimensional (3D) reconstruction algorithms, which can be used to generate a three dimensional model or rendering of an object based on multiple views of the object from different camera angles. Challenges exist, however, in efficiently generating multi-view images, with consistency and accuracy among the views.

### SUMMARY

Disclosed herein is a computing system for generation of multi-view images. According to one aspect, the computing system comprises processing circuitry and memory storing instructions that, when executed, cause the processing circuitry to implement a diffusion transformer model that has been trained on a dataset of multi-view images and corresponding text captions, each multi-view image including a plurality of views of an object generated from a plurality of camera poses. The model is configured to receive an inference-time text prompt describing a target object and generate an inference-time output multi-view image including a plurality of views of the target object generated from the plurality of camera poses. The diffusion transformer model comprises a text encoder configured to receive the inference-time text prompt and encode the inference-time text prompt as text embeddings, and a set of one or more latent diffusion transformer blocks configured to receive an inference-time noisy latent representation and generate an inference-time denoised latent representation. Each of the latent diffusion transformer blocks includes a plurality of adaptive normalization layers conditioned on camera pose and timestep, and at least one dense cross-view attention block configured to compute cross attention on intermediate latent representations and generate cross-view contextualized latent representations. The diffusion transformer model further comprises a decoder configured to receive the inference-time denoised latent representation and generate one or more of the views of the inference-time output multi-view image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computing system configured to implement a text-to-multi-view generation model, according to a first embodiment of the present disclosure.

FIG. 2 is a schematic view showing the positioning of the camera poses from which views are rendered to generate multi-view images, according to the embodiment of FIG. 1, wherein the camera poses are placed at even azimuthal distances from each other on a circular orbit.

FIG. 3 is a schematic view of the conditioning of the adaptive normalization layers (e.g., scale and scale, shift layers) on the camera pose extrinsic and timestep, according to the embodiment of FIG. 1.

FIG. 4 is a schematic view of a computing system configured to implement a text-to-multi-view generation model in a training configuration, according to the embodiment of FIG. 1.

FIG. 5 is a schematic view of a variational autoencoder of the diffusion transformer model, which includes a 2D and a 3D autoencoder, according to a second embodiment of the present disclosure.

FIG. 6 is a flowchart of a method for performing multi-view image generation, according to the example of FIG. 1.

FIG. 7 shows additional steps of the method of FIG. 6 that are performed to condition the multi-view image generation on timesteps and camera poses.

FIG. 8 is a table that shows a quantitative evaluation of the first (Model A) and second (Model B) embodiments of the text-to-multi-view generation models of the present disclosure and prior text-to-multi-view generation models.

FIG. 9 shows text-to-4-view results of the first embodiment (Model A) compared against MVDream.

FIGS. 10A and B show text-to-32-view results of the finetuned MVDream (A), VideoMV (B), and first (C) and second (D) embodiments of the present disclosure.

FIG. 11 is a table illustrating a quantitative evaluation of the first (Model A) and second (Model B) embodiments with and without fine-tuning the diffusion transformer model and variational autoencoder on high quality data.

FIG. 12 shows multi-view images output from Model A with finetuning (A) and without finetuning (B) on high quality data.

FIG. 13 shows a schematic view of an example computing environment in which the text-to-multi-view generation model can be implemented.

### DETAILED DESCRIPTION

Generative machine learning models have been developed that can take text inputs and generate images based on the text inputs. One type of model that can be trained to perform this task is the diffusion model. Recently, diffusion models have been trained to generate multiple views of an object described by a textual prompt, with each view depicting the object from a different viewpoint. This multi-view generative capability serves as a bridge toward text-to-3D generation, since the generated multi-view images can be used as an input to a 3D reconstruction algorithm to generate or reconstruct a 3D asset, such as a 3D mesh or avatar.

One technical challenge associated with generation of multi-view images that are used in 3D asset generation is that generation of multi-view images of sufficiently high quality and consistency between views is difficult. The challenge of consistency between views is not faced in conventional text-to-image generation. Prior text-to-video approaches have attempted to address temporal consistency, where, for example, optical flow has been used to maintain coherence across frames. However, such approaches have been possible because changes in appearance and position of objects in video frames are relatively small and follow expected patterns on a frame-to-frame basis. In contrast, promoting consistency across multiple viewpoints in text-to-multi-view generation is more challenging than video frame-to-frame consistency due to the significant variations in object appearances from different viewpoints. Lack of consistency in the generated multi-view images can result in less satisfactory results in the final 3D output.

One prior approach to text-to-multi-view image generation is a convolutional U-Net multi-view diffusion model trained to generate multi-view images of an object. The U-Net multi-view diffusion model includes conditioning on camera extrinsic parameters and a 3D self-attention mechanism to promote multi-view consistency. For example, in one prior implementation, a U-Net multi-view diffusion model has been proposed that is trained to generate four orthogonal views at each inference pass. Four views are generally not enough for generation of a high-fidelity 3D asset. While multiple passes can be employed to generate more views with this approach, the generation of more than four images in multiple passes is computationally expensive and results in poor consistency between images with this prior model.

To address the above technical challenges, embodiments of a text-to-multi-view generation model are presented herein. A first embodiment of the text-to-multi-view generation model (also referred to as Model A herein) uses a diffusion model with a transformer-based architecture and integrates dense cross-view attention and frame-wise camera conditioning to facilitate the generation of consistent and dense multi-view images. The training data includes a large dataset of multi-view images rendered from annotated 3D assets.

Unfortunately, generating dense multi-view images with such a model incurs increased computational costs. Specifically, the computation required by dense cross-view attention increases quadratically with the number of views. To address this challenge, a second embodiment of a text-to-multi-view generation model is presented (also referred to as Model B herein), which leverages spatio-temporal latent representations within a diffusion model. This approach offers two technical benefits: (1) temporal compression reduces the number of latent representations, resulting in a significant improvement in the computational efficiency of diffusion blocks; (2) during decoding, the model generates a plurality of views for each latent representation, leading to improved consistency among views decoded from the same latent representation.

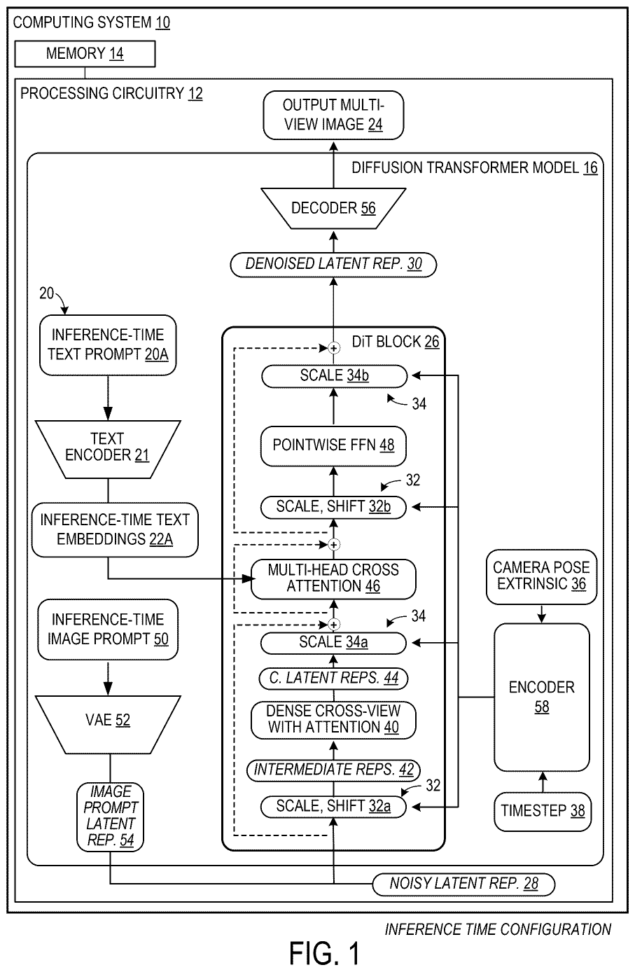

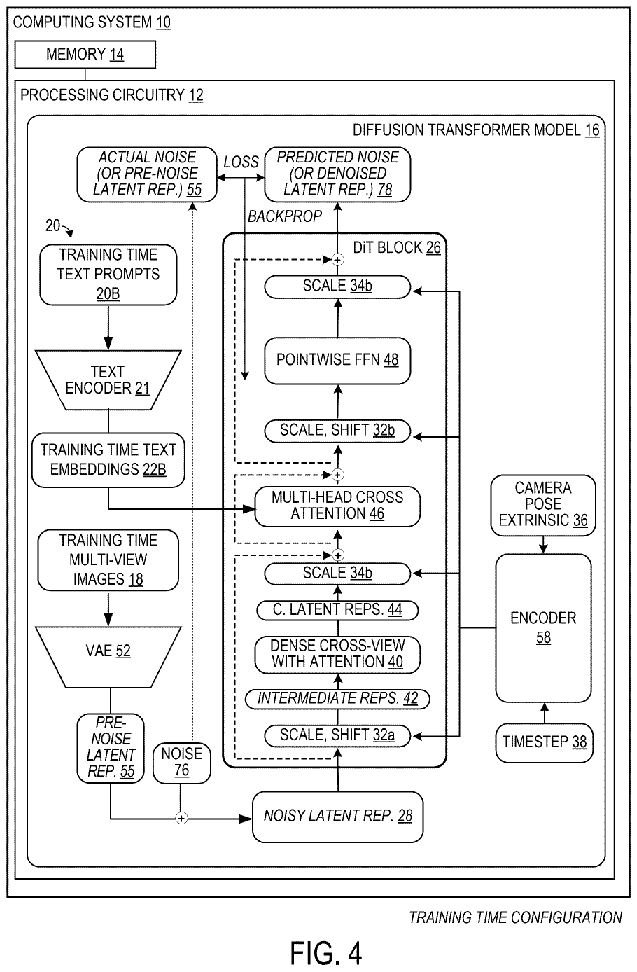

The text-to-multi-view generation model is discussed in further detail below. As shown in FIG. 1, a first embodiment of the present disclosure provides a computing system 10 according to one example implementation. Computing system 10 includes processing circuitry 12 and memory 14 storing instructions that, when executed, cause the processing circuitry 12 to implement the various functions described below. Computing system 10 comprises a diffusion transformer model 16 that has been trained on a dataset of training-time multi-view images 18 and corresponding training-time text prompts 20B (both shown in FIG. 4, described below). Each multi-view image 18 includes a plurality of views of an object generated from a plurality of camera poses. The camera poses are virtual camera poses that define the view from which the object is rendered to produce the multi-view images.

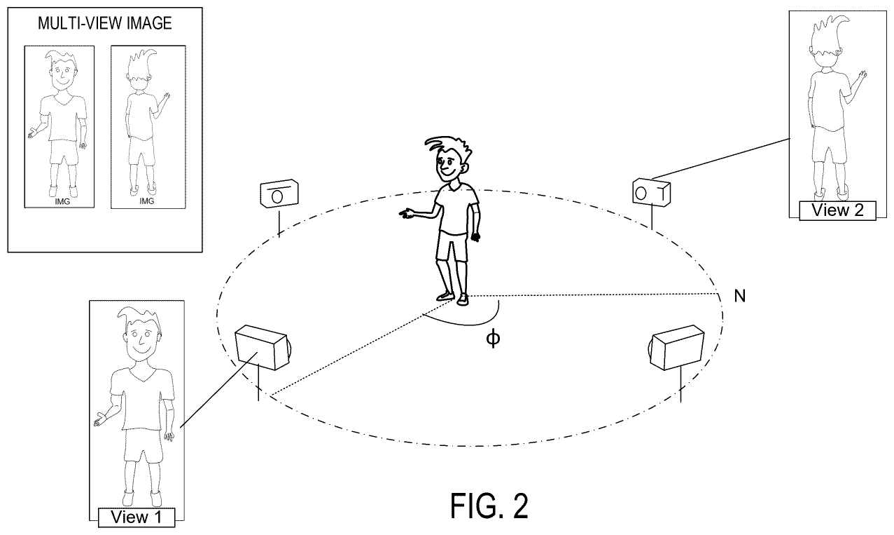

The diffusion transformer model 16 is configured to receive an inference-time text prompt 20A describing a target object and generate an output multi-view image 24 including a plurality of views of the target object generated from the plurality of camera poses. For example, the number of views in the output multi-view image 24 generated at inference time by the diffusion transformer model 16 is in a range from 8 to 64. The camera poses can be positioned on even azimuthal distances from each other on a circular orbit at fixed elevation, as shown in FIG. 2. Other configurations are possible, such as a dynamic orbit, wherein the camera poses are positioned at varying elevations.

As shown in FIG. 1, the diffusion transformer model 16 comprises a text encoder 21 configured to receive the inference-time text prompt 20A and encode the inference-time text prompt 20A as inference-time text embeddings 22A. The text encoder 21 can be FLAN-T5, BERT, or other text encoder model. The diffusion transformer model 16 further comprises a set of one or more latent diffusion transformer blocks 26 configured to receive an inference-time noisy latent representation 28 and generate an inference-time denoised latent representation 30. Each of the latent diffusion transformer blocks 26 includes a plurality of adaptive normalization layers conditioned on a camera pose extrinsic 36 and a timestep 38. The adaptive normalization layers include scale and shift layers 32 and scale layers 34. Scale and shift layers 32 can include a first scale and shift layer 32a and a second scale and shift layer 32b, while scale layers 34 can include a first scale layer 34a and a second scale layer 34b. Each of the latent diffusion transformer blocks 26 further includes at least one dense cross-view attention block 40 configured to compute cross attention on intermediate latent representations 42 and generate cross-view contextualized latent representations 44. Each of the set of diffusion transformer blocks 26 can further comprise a multi-head cross attention block 46, and a pointwise feed-forward network 48.

The multi-head cross attention block 46 of the diffusion transformer blocks 26 is used to condition the generation of the inference-time denoised latent representation 30 on the inference-time text embeddings 22A. Before being processed by the set of diffusion transformer blocks 26, the noisy latent representations 28 can be converted to encoded latent tokens. Each noisy latent representation ∈ [symbol] can be divided into patches of size p×p, resulting in encoded latent tokens

$$∈ {ℝ}^{\frac{I}{p} \times \frac{I}{p} \times d} .$$

The dense cross-view attention block 40 performs cross-attention over all tokenized intermediate latent representations

$$( {( \frac{I}{p} )}^{2} \times F$$

tokens, where F is the number of latent representations) to enhance the consistency and coherence between encoded latent tokens. The diffusion transformer model 16 further comprises a decoder 56 configured to receive the inference-time denoised latent representation 30 and generate one or more of the views of the output multi-view image 24.

In some implementations, the processing circuitry 12 is further configured to encode an inference-time image prompt 50 at a variational autoencoder 52 of the diffusion transformer model to generate an image prompt latent representation 54 and concatenate the image prompt latent representation 54 with the inference-time noisy latent representation 28, to thereby condition the generation of the output multi-view image 24 on the image prompt 50.

In some implementations, the output multi-view image 24 can be fed to a 3D model generator that generates a 3D mesh from the output multi-view image 24. An avatar can be generated from the 3D mesh. The avatar can be configured to be controlled by a user input. For example, an image of a face or body of the user captured by a mobile phone camera can be used as a driving image to drive animation of the avatar. Alternatively, keyboard or touch inputs can be used to control movement of the avatar. Further, the diffusion transformer model 16 can be used as a prior in optimizing a 3D representation via score distillation sampling.

The diffusion transformer model 16 includes camera conditioning, wherein the camera pose extrinsic 36 is provided as a condition in the diffusion transformer blocks 26, such that the inference-time denoised latent representation 30 is generated to correspond to the associated view indicated by the camera pose extrinsic 36. In some implementations, the camera pose extrinsic 36 can be a 4×4 extrinsic camera matrix or a 6 degree of freedom (DoF) vector that defines the position and orientation of the camera. Alternatively, the camera pose extrinsic can be expressed as a text label, or encoded as a numeric value, for example.

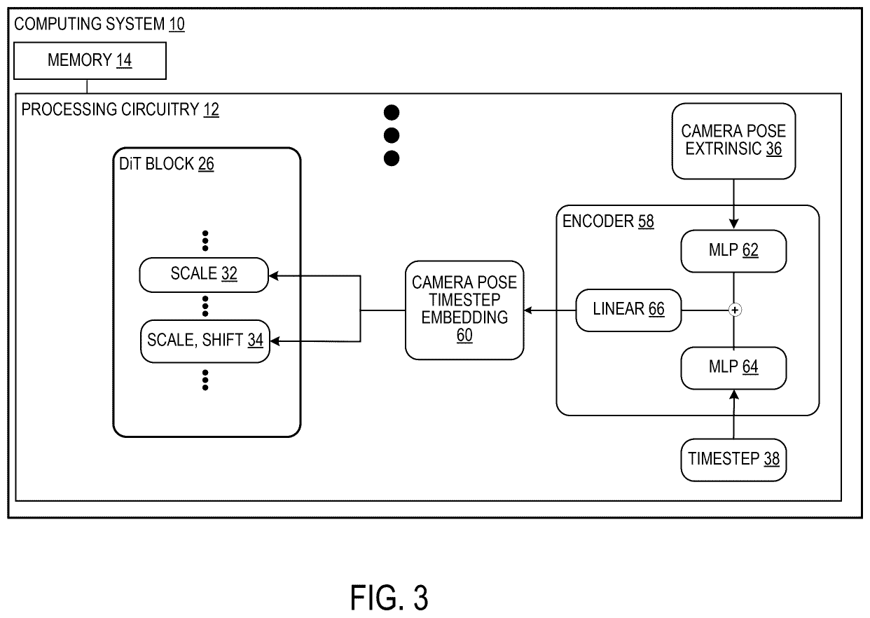

As shown in FIG. 3, the processing circuitry 12 can be further configured to receive the respective camera pose extrinsic 36 for each inference-time noisy latent representation 28. The processing circuitry 12 can be further configured to embed, using an encoder 58, the camera pose extrinsic 36 and the timestep 38 to generate a respective camera pose timestep embedding 60. In some implementations, the encoder 58 comprises a first multi-layer perceptron network 62 configured to receive the camera pose extrinsic 36 and generate a camera pose embedding, a second multi-layer perceptron network 64 configured to receive the timestep 38 and generate a timestep embedding, and a linear layer 66 configured to receive a combination of the timestep embedding and camera pose embedding and generate the camera pose timestep embedding 60.

The processing circuitry 12 is further configured to adjust scale and shift parameters in the adaptive normalization layers (e.g., the scale and shift layers 32a-b and shift layers 34a-b) with the camera pose timestep embedding 60, to thereby condition the plurality of adaptive normalization layers (e.g., the scale and shift layers 32a-b and shift layers 34a-b) on the camera pose extrinsic 36 and the timestep 38. For example, an AdaLN-Single approach can be used, wherein a global set of scale and shift parameters in the adaptive normalization layers are computed, based at least in part on the timestep 38. The global set of scale and shift parameters can then be combined with the camera pose timestep embeddings 60 to generate the block-specific scale and shift parameters.

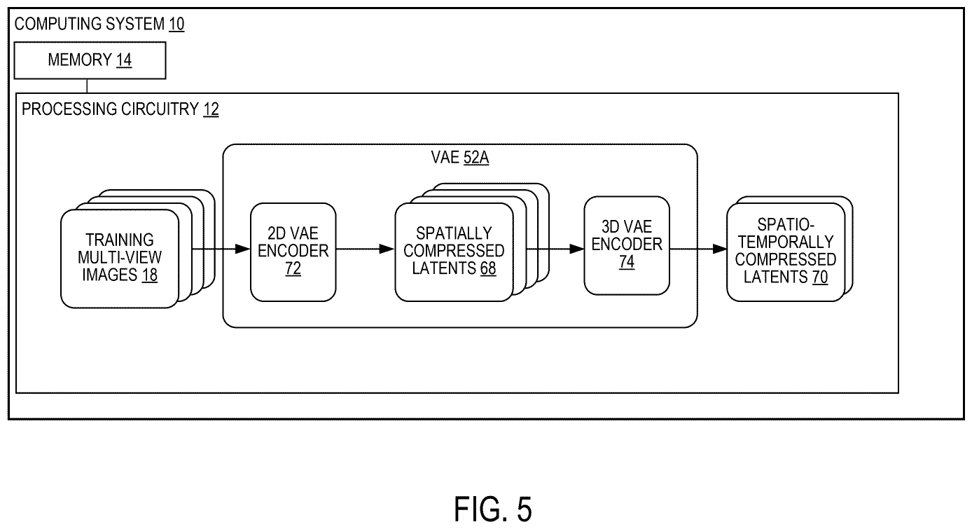

In some implementations (e.g., the second embodiment described below in relation to FIG. 5), in which spatio-temporally compressed latent representations are used, each spatio-temporally compressed latent representation maps to a plurality of views. For example, in some implementations, each spatio-temporally compressed latent representation (z_{i:i+4}) is mapped to views i through i+4. In such implementations, the i-th camera pose extrinsic can be used to provide conditioning for z_{i:i+4}, as described above.

During training the diffusion transformer model 16, as shown in FIG. 4, the processing circuitry 12 is further configured to, at a variational autoencoder 52, generate training-time pre-noise latent representations 55 based on a training-time multi-view image 18. In some implementations, the variational autoencoder 52 is configured to receive the training-time multi-view image 18 and for each of the plurality of views of the training-time multi-view image generate spatially compressed latent representations 68 of each of the plurality of views of the training-time multi-view image 18. Alternatively, in some implementations, such as the second embodiment show in FIG. 5 and described below, a variational autoencoder 52A can be provided that is configured to receive the training-time multi-view image 18 and for each of a plurality of subsets of the views of the training-time multi-view image 18, generate spatio-temporally compressed latent representations 70 of each of the subsets of the views of the training-time multi-view image 18.

A second embodiment of the present disclosure uses spatio-temporally compressed latent representations 70. The second embodiment is based on and includes the features described in relation to FIGS. 1-4 of the first embodiment, and additionally includes the features described in FIG. 5. As shown in FIG. 5, the variational autoencoder 52A can comprise a 2D autoencoder 72 that generates the spatially compressed latent representations 68 followed by a 3D autoencoder 74 that generates the spatio-temporally compressed latent representations 70. The use of temporal compression reduces the number of latent representations, improving the computational efficiency of both model training and inference. In addition, the use of temporal compression improves consistency between views generated from the same spatio-temporally compressed latent representation 70. The 3D VAE of OpenSora v1.2 can be used as the variation autoencoder 52A.

Returning to the first embodiment in FIG. 4, the processing circuitry 12 is further configured to encode a training-time text prompt 20B as training-time text embeddings 22B at the text encoder 21. The processing circuitry 12 is further configured to receive the training-time pre-noise latent representations 55 and add noise 76 to the training-time pre-noise latent representations 55 to generate training-time noisy latent representations 28 in a forward diffusion process. The training-time noisy latent representations 28 are then inputted to the set of one or more diffusion transformer blocks 26 configured to generate training-time denoised latent representations 78 based at least in part on the training-time noisy latent representations 28. The processing circuitry 12 is further configured to compute a training loss term between the training-time denoised latent representations 78 and the training-time pre-noise latent representations 55 using a diffusion loss function. The training loss term can be a combination of a mean square error term and a variational bound term. For example, the training loss term can be

$${L}_{MSE} = {𝔼}_{{x}_{0} , ϵ , t} [ {‖ ϵ - \hat{ϵ} ‖}_{2}^{2} ] ,$$

$${L}_{VB} = {𝔼}_{{x}_{0} , ϵ , t} [ VB ( {x}_{t} , {x}_{0} , t ) ] ,$$

$${L}_{total} = {L}_{MSE} + {L}_{VB}$$

where L_{MSE} penalizes incorrect noise predictions, and L_{VB} penalizes the variational bound. The processing circuitry 12 is further configured to perform gradient descent with respect to the diffusion loss function to update parameters in the diffusion transformer model 16 based on the training loss term.

A training decomposition strategy can be used for training the diffusion transformer model 16. In one example training decomposition strategy, the diffusion transformer model 16 is first trained to generate 4 views, which are on placed on random azimuthal positions of 32 views along a horizontally circular orbit. The diffusion transformer model 16 is then trained to generate 32 views, which are placed on even azimuthal distances from each other on a horizontally circular orbit. When the variational autoencoder 52A of FIG. 5 is used, the diffusion transformer model 16 is then trained on spatio-temporally compressed latent representations 70 generated using a 3D autoencoder 74. Finally, the diffusion transformer model 16 is fine-tuned on a high-quality subset of training-time multi-view images 18, to enhance the quality and consistency of generated output multi-view images 24.

The variational autoencoder 52 can be trained separately from the diffusion transformer model 16. The variational autoencoder 52 can be initialized with the 2D VAE weights of Stable Diffusion XL (SDXL), and where variational autoencoder 52A of FIG. 5 is used a 3D VAE 74 (providing temporal compression) can be implemented using 3D casual convolution. The following training steps can be followed: (1) The 2D VAE 72 (providing spatial compression) weights are frozen during training, and a similarity regularization is applied to make the features of the spatio-temporally compressed latent representations 70 similar to those of the spatially compressed latent representations 68. The objective is to reconstruct the 2D latent representations 68 accurately. (2) Where temporal compression is used as in variational autoencoder 52A, the similarity regularization is removed to just train the temporal compression. (3) Then, the entire variational autoencoder 52 is trained, with an objective to reconstruct the original videos accurately. Following initial training, the variational autoencoder 52 can be fine-tuned on multi-view images.

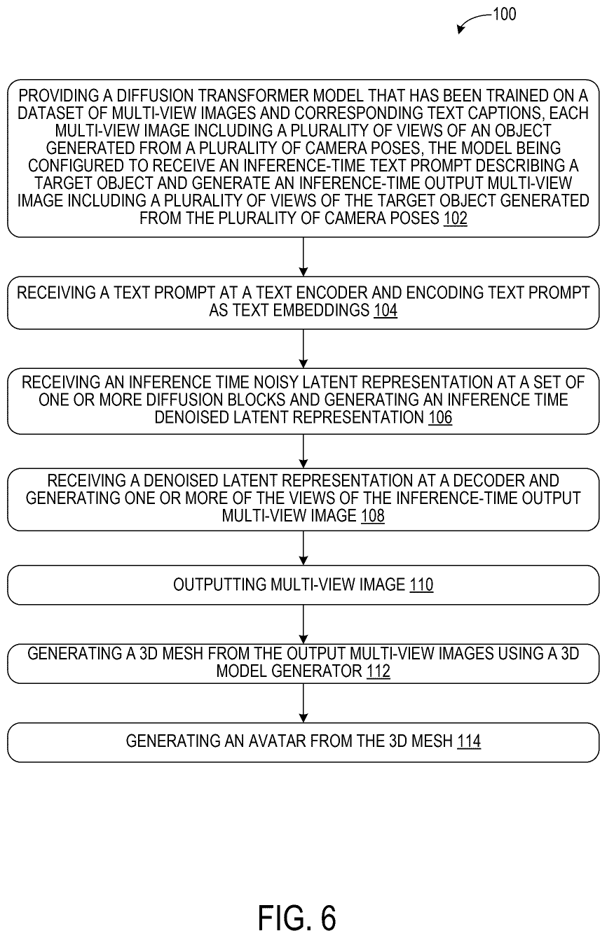

FIG. 6 shows a flowchart of a computerized method 100 for performing multi-view image generation, according to one example implementation of the present disclosure. Method 100 can be implemented using the hardware and software components of computing system 10 described above, or other suitable hardware and software components, as desired. At step 102, method 100 includes providing a diffusion transformer model that has been trained on a dataset of multi-view images and corresponding text captions, each multi-view image including a plurality of views of an object generated from a plurality of camera poses. The model is configured to receive an inference-time text prompt describing a target object and generate an inference-time output multi-view image including a plurality of views of the target object generated from the plurality of camera poses. At step 104, method 100 includes receiving, via a text encoder of the diffusion transformer model, an inference-time text prompt and encoding the inference-time text prompt as text embeddings. At step 106, the method further includes receiving, via a set of one or more diffusion transformer blocks of the diffusion transformer model, an inference-time noisy latent representation and generating an inference-time denoised latent representation. Each of the set of diffusion transformer blocks includes a plurality of adaptive normalization layers conditioned on a camera pose extrinsic and a timestep, and at least one dense cross-view attention block configured to compute cross attention on intermediate latent representations and generate cross-view contextualized latent representations. A multi-head cross attention block of the diffusion transformer blocks can be used to condition the generation of the denoised latent representation on the inference-time text embeddings. As discussed above, the camera poses indicate a positioning and orientation of the camera for each image of the multi-view image. In one specific example, the plurality of camera poses can be positioned on even azimuthal distances from each other on a circular orbit. Other configurations are possible.

At step 108, method 100 further includes receiving, via a decoder of the diffusion transformer model, the inference-time denoised latent representation and generating one or more of the views of the output multi-view image. At step 110, method 100 further includes outputting output multi-view image. For example, the number of views in the output multi-view image generated at inference time by the diffusion transformer model is in a range from 8 to 64. At step 112, method 100 further includes generating a 3D mesh from the output multi-view image using a 3D model generator and at step 114, generating an avatar from the 3D mesh.

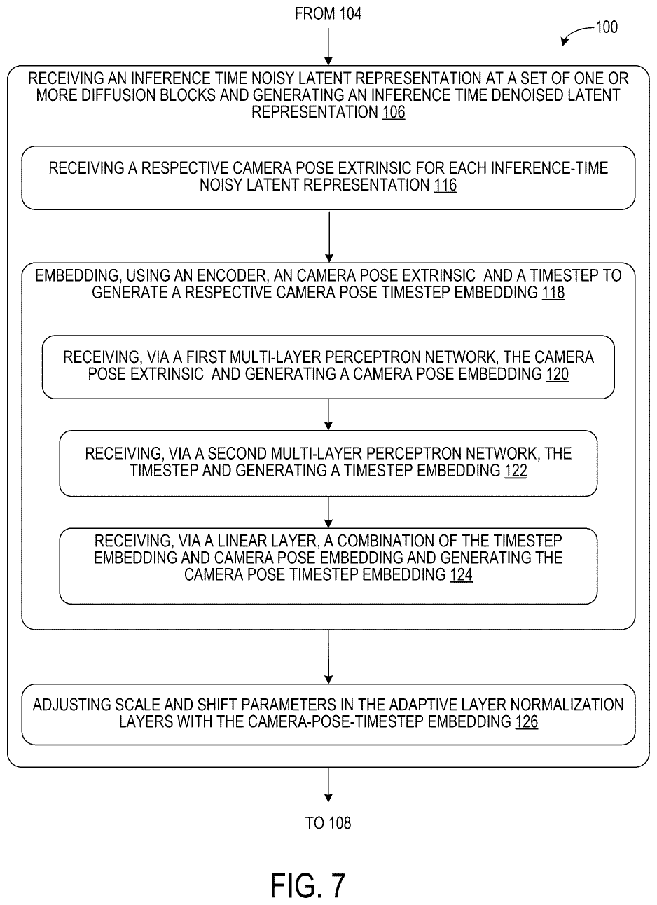

FIG. 7 shows additional steps that can be used to accomplish step 106 described above, which conditions the image generation on timesteps and camera poses. At step 116, method 100 further includes receiving a respective camera pose extrinsic for each inference-time noisy latent representation. At step 118, method 100 further includes embedding, using an encoder, the camera pose extrinsic and the timestep to generate a respective camera pose timestep embedding. Step 118 can be accomplished at least in part by, as shown at 120, receiving, via a first multi-layer perceptron network, the camera pose extrinsic and generating a camera pose embedding. Step 118 further can include, as shown at 122, receiving, via a second multi-layer perceptron network, the timestep and generating a timestep embedding. Step 118 further can include, as shown at 124, receiving, via a linear layer, a combination of the timestep embedding and the camera pose embedding and generating the camera pose timestep embedding. At step 126, the method 100 further includes adjusting scale and shift parameters in the adaptive normalization layers with the camera pose timestep embedding, to thereby condition the plurality of adaptive normalization layers on the camera pose extrinsic and the timestep.

In the following sections, example implementations of the above-described systems and methods will now be described, including observations on experimental results and ablation studies. Model A and Model B are evaluated against existing text-to-multi-view methods in terms of image quality and consistency, demonstrating superior performances. In particular, Model B proves to be the most efficient text-to-multi-view method with competitive quality, generating 32 multi-view images in just around 5 seconds.

In one experiment, the Objaverse dataset was used to render multi-view images for use in training Model A and Model B. The rendering protocols used in MVDream were followed to prepare a dataset comprising of approximately 350K distinct objects. The BS-Objaverse 660K dataset was also used, which provides GPT4-Vision-powered dense captions for 660K objects in the Objaverse dataset. For overlapping objects between the 350K dataset and BS-Objaverse 660K (~250K), the dense captions were used where available, otherwise, the names and tags of the objects were used as the text caption. For the high quality subset of Objaverse, objects with less than 10 “likes” in the metadata were filtered out. It was visually confirmed that the overall complexity and quality of the 3D objects in Objaverse are strongly correlated with the number of likes. This yields around 70k high-quality Objaverse data elements. To improve quality, 2D image data was mixed into this training data, by incorporating the SAM dataset used in SAM. SAM-LLaVA-Captions10M was used, which contains dense captions with high concept density for improved text-image alignment. In particular, a subset of the SAM data (~500K) was used. During training, training was performed on multi-view images of Objaverse for 70% of the time, and the single-view images of SAM for 30% of the time.

Model A was trained to generate 4, 32 views at image dimensions of 512×512. The multi-view images generated by Model A assumes that the object described by the text prompt is placed at the center, and the camera is orbiting around the object at a fixed elevation. Model A was initialized from the PixArt-Σ-512 model, inheriting its text-to-image generation capabilities. All trainings are run on 8 A100 80 GB GPUS, with a batch size (total number of images per iteration) of 128 per GPU. Model A was optimized using the AdamW optimizer, at a constant learning rate of 1e⁻⁵. The 4 training stages for the base model took 50K steps (3 days), 50K (3 days), 50K (3 days), and 20K (1.5 days) steps, respectively. DPMSolver++ was used with sampling for 14 steps, and a CFG guidance scale of 6.0. The training of Model B was accomplished with the same training procedure; however, it was trained on spatio-temporal latents produced from a 3D variational autoencoder.

Analysis shows that using an unmodified version of OpenSora-VAE v1.2 results in suboptimal reconstruction results and generative outputs. This is likely because the desired orbital views have high motion dynamics, which is not common in many video datasets. To this end, 32-orbital view renderings were rendered of the Objaverse dataset, and used as a finetuning dataset to fine tune the variational autoencoder and make it more adept at reconstructing orbital videos, using a combination of reconstruction loss, LPIPs loss, and KL divergence loss, as follows:

$${L}_{VAE} = \frac{1}{N} {\sum }_{i = 1}^{N} ( \frac{{‖ {x}_{i} - {\hat{x}}_{i} ‖}_{1}}{exp ( logvar )} + logvar ) + {λ}_{LPIPS} \cdot LPIPS ( x , \hat{x} ) + {λ}_{K L} \cdot {D}_{K L} ( q ( z \vert x ) \vert \vert p ( z ) )$$

The training scheme described above was used to finetune OpenSora-VAE v1.2 on 32-frame videos rendered from Objaverse, using the losses in Eq. (1). A batch size of 1 was used, and the Adam optimizer was used with a learning rate of 1e-5. The following values were set: λ LPIPS=0.1, and λ KL=1e-6.

Model A was evaluated on 100 single-object prompts of the T3bench, and 110 prompts from GPTEval3D, resulting in a total of 210 prompts. The quality, consistency, and latency of Model A and Model B were evaluated against the baseline methods of MVDream and VideoMV. MVDream proposed to generate 4 views, while VideoMV proposed to generate 24 views; to this end, comparisons were made across 4, 24 and 32 views. As MVDream was only trained to generate 4 orthogonal views, MVDream was finetuned with random viewpoints to be adept at generating a greater number of views. OpenSora was also finetuned on 32-frame orbital videos of Objaverse for comparison (OpenSorafinetuned).

For quality evaluation, the following are reported: (1) the FID against 32 views of 1000 high-quality Objaverse objects (32k images), (2) the FID against 32 randomly generated images by PixArt-Σ for each of the 210 prompts, (3) the inception score (IS), (4) the CLIP-R score, which measures the recall to signify text-image alignment, and (5) the CLIP score, which quantifies the similarity between the image and text embeddings. For consistency evaluation, given F generated views, every even-numbered frame is used to reconstruct a NeRF using the nerfacc implementation of Instant-NGP [24]. Then the odd-numbered views are rendered, and the PSNR, LPIPS and SSIM metrics are measured for consistency.

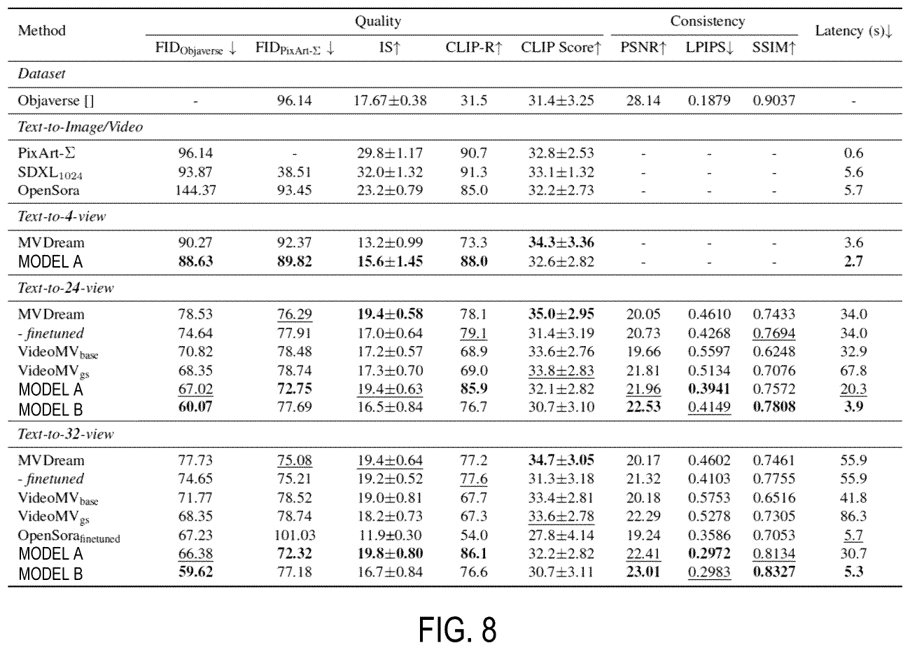

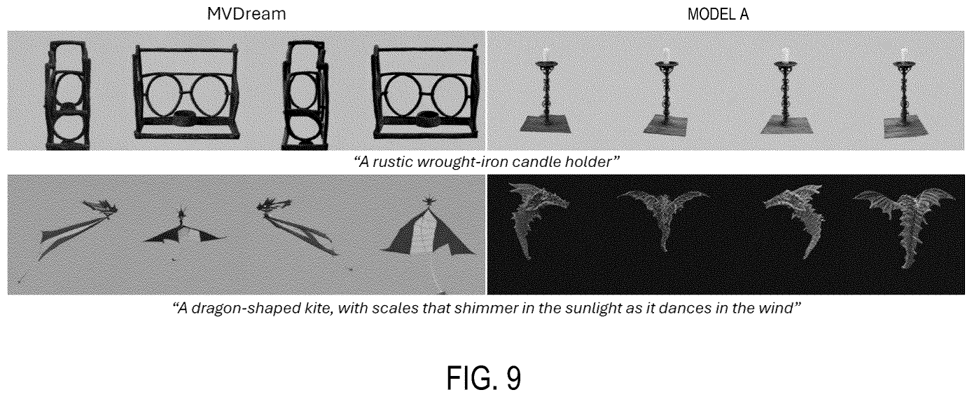

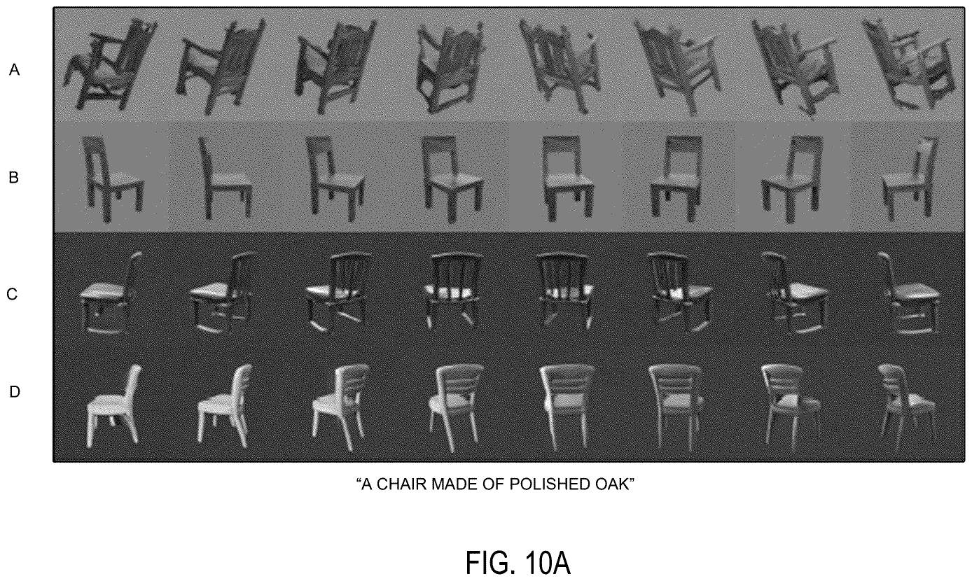

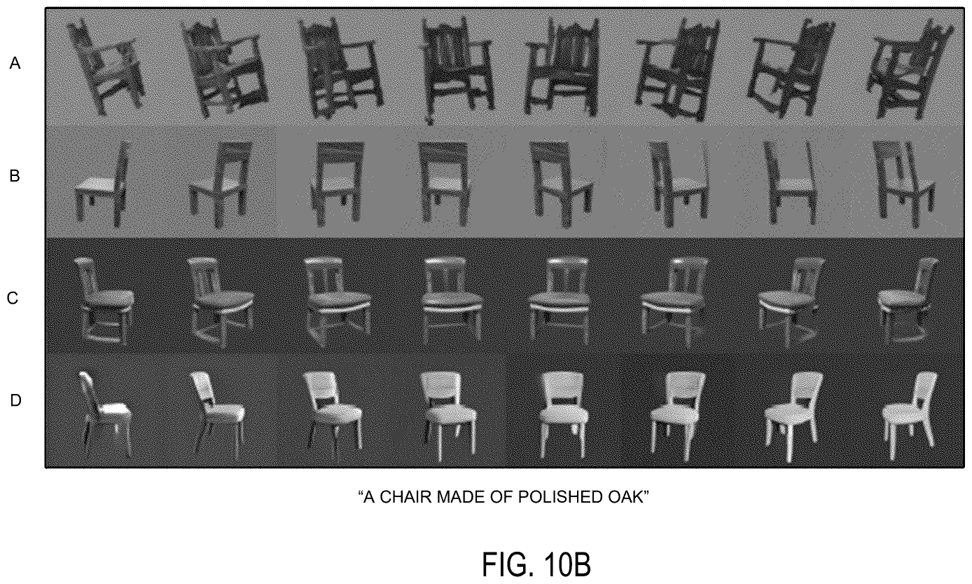

The consistency for 4-view generation is not measured, since four views are insufficient for reconstruction. The results are illustrated in FIG. 8. It can be seen that across 4, 24 and 32 views, Model A and Model B exhibit the best FID scores. The Model A also shows the best IS and CLIP-R scores, while MVDream shows the best CLIP Score. This shows that while MVDream generated views have the highest absolute CLIP-embedding similarities, Model A generated views have the highest relative image-text alignment. In terms of consistency, Model B exhibits the best PSNR and SSIM, while Model A shows slightly better LPIPS. This improvement in consistency from Model A to Model B likely derives from having 4 frames generated per latent representation, i.e., increased consistency for frames generated from the same latent representation. Model B shows the lowest latency overall, demonstrating its superior efficiency in generating multi-view images. Qualitative results are provided for 4-view generation in FIG. 9. In FIG. 10A and FIG. 10B, example 32-view output images are shown for the finetuned MVDream (A), VideoMV (B), Model A (C), and Model B (D), where it can be seen that Model A and Model B yield visually compelling results with high quality and consistency.

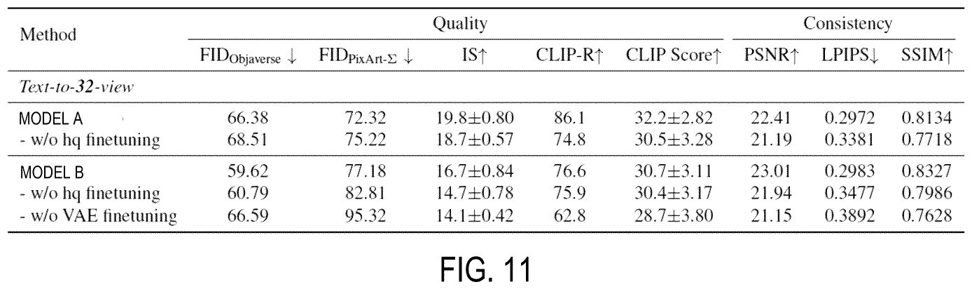

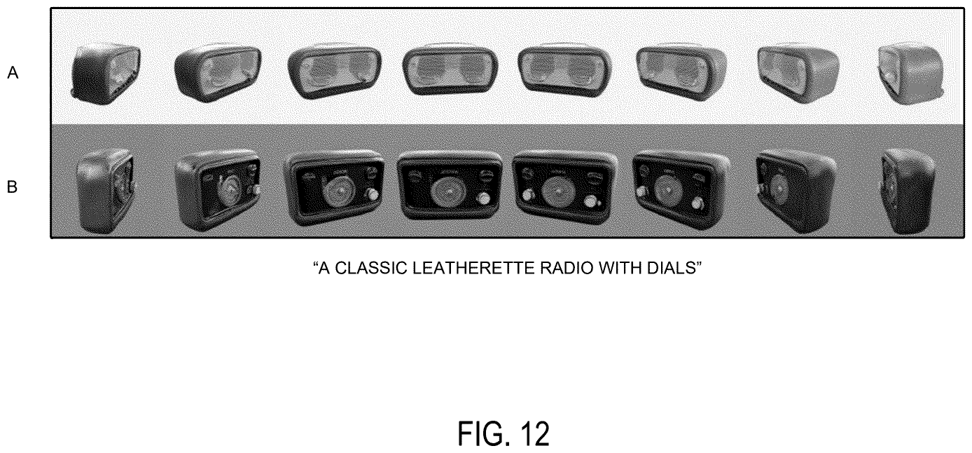

The effect of (1) variational autoencoder finetuning and (2) finetuning of Model A with high-quality data were evaluated. The quantitative comparison is shown in FIG. 11, where both schemes are shown to be beneficial. The generated results from Model A with finetuning (A) and without finetuning (B) are shown in FIG. 12, where it can be seen that high quality finetuning improved generation quality.

A first embodiment of the present disclosure, referred to as Model A, and a second embodiment, referred to as Model B, were presented herein. These are efficient text-to-multi-view diffusion models that generate dense, consistent images, enabling direct 3D reconstruction from the generated views. The models are built on a DiT-based text-to-image diffusion framework by (1) applying dense self-attention across all multi-view images during denoising to enhance multi-view consistency, and (2) integrating extrinsic camera control via adaptive layer normalization, ensuring camera pose coherence across views. Additionally, the second embodiment leverages spatio-temporal latent representations, significantly improving inference efficiency by operating on effectively fewer latent representations. A training strategy decomposition scheme was designed to train the text-to-multi-view diffusion models in an effective and efficient manner. The quantitative and qualitative evaluations performed herein demonstrate that the text-to-multi-view diffusion models efficiently produce high-quality, multi-view images with state-of-the-art consistency. This work opens pathways for efficient and effective generation of multi-view images, 3D objects, and scene-level content.

### Computing Environment

In some embodiments, the methods and processes described herein may be tied to a computing system of one or more computing devices. In particular, such methods and processes may be implemented as a computer-application program or service, an application-programming interface (API), a library, and/or other computer-program product.

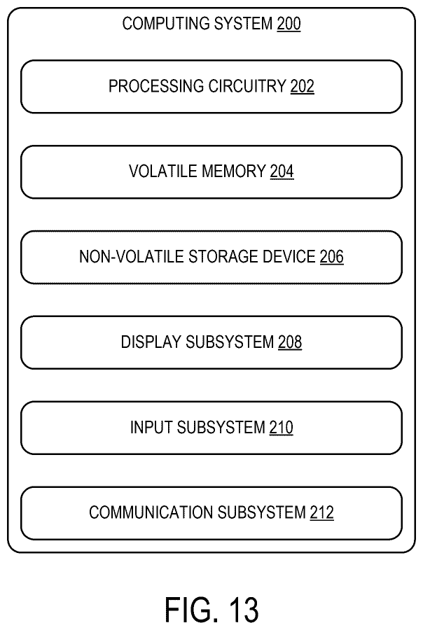

FIG. 13 schematically shows a non-limiting embodiment of a computing system 200 that can enact one or more of the methods and processes described above. Computing system 200 is shown in simplified form. The text-to-multi-view generation models described above can be implemented by the computing system 200. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, comprising processing circuitry and memory storing instructions that, when executed, cause the processing circuitry to implement a diffusion transformer model. The diffusion transformer model has been trained on a dataset of multi-view images and corresponding text captions, each multi-view image including a plurality of views of an object generated from a plurality of camera poses. The diffusion transformer model is configured to receive an inference-time text prompt describing a target object and generate an inference-time output multi-view image including a plurality of views of the target object generated from the plurality of camera poses. The diffusion transformer model includes a text encoder configured to receive the inference-time text prompt and encode the inference-time text prompt as inference-time text embeddings. The diffusion model further includes a set of one or more latent diffusion transformer blocks configured to receive an inference-time noisy latent representation and generate an inference-time denoised latent representation. Each of the one or more latent diffusion transformer blocks further includes a plurality of adaptive normalization layers conditioned on camera pose and timestep, and at least one dense cross-view attention block configured to compute cross attention on intermediate latent representations and generate cross-view contextualized latent representations. The diffusion transformer model further includes a decoder configured to receive the inference-time denoised latent representation and generate one or more of the views of the inference-time output multi-view image. The above features can have the technical effect of increasing the speed of generating multi-view images via a diffusion model and improving the visual consistency between generated multi-view images.

According to this aspect, the number of views in the output multi-view image generated at inference time by the diffusion transformer model can be in a range from 8 to 64. The above features can have the technical effect of producing multiple views of an object that can be used for generating three dimensional assets.

According to this aspect, the plurality of camera poses can be positioned on even azimuthal distances from each other on a circular orbit. The above features can have the technical effect of producing multiple views of an object that represent a well-balanced group of perspectives on the object.

According to this aspect, a multi-head cross attention block of the one or more diffusion transformer blocks can be used to condition the generation of the inference-time denoised latent representation on the inference-time text embeddings. The above features can have the technical effect of providing textual guidance for the generation of the multi-view images.

According to this aspect, the processing circuitry can be further configured to encode an image prompt at a variational autoencoder to generate an image prompt latent representation and concatenate the image prompt latent representation with the inference-time noisy latent representation, to thereby condition the generation of the inference-time output multi-view image on the image prompt. The above features can have the technical effect of providing visual guidance for the generation of the multi-view images.

According to this aspect, the processing circuitry can be further configured to: receive a respective camera pose extrinsic for each inference-time noisy latent representation; embed, using an encoder, the camera pose extrinsic and a timestep to generate a respective camera pose timestep embedding; and adjust scale and shift parameters in the adaptive normalization layers with the camera pose timestep embedding, to thereby condition the plurality of adaptive normalization layers on the camera pose extrinsic and timestep. The above features can have the technical effect of conditioning the generation of multi-view image on camera poses and timesteps.

According to this aspect, the encoder can comprise: a first multi-layer perceptron network configured to receive the camera pose extrinsic and generate a camera pose embedding; a multi-layer perceptron network configured to receive the timestep and generate a timestep embedding; and a linear layer configured to receive a combination of the timestep embedding and camera pose embedding and generate the camera pose timestep embedding. The above features can have the technical effect of combining the camera pose and the timestep embeddings into a single conditioning embedding.

According to this aspect, during training the diffusion transformer model, the processing circuitry can be further configured to: at a variational autoencoder of the diffusion transformer model, generate training-time pre-noise latent representations based on a training-time multi-view image; encode a training-time text prompt as a training-time text embedding at the text encoder; receive the training-time pre-noise latent representations; and add noise to the training-time pre-noise latent representations to generate training-time noisy latent representations in a forward diffusion process. The processing circuitry can be further configured to, at the set of one or more diffusion transformer blocks, generate training-time denoised latent representations based at least in part on the training-time noisy latent representations; compute a training loss term between the training-time denoised latent representations and the training-time pre-noise latent representations using a diffusion loss function; and update parameters in the diffusion transformer model based on the training loss term. The above features can have the technical effect of training a diffusion transformer model for the generation of multi-view images.

According to this aspect, the training loss term can be a combination of a mean square error term and a variational bound term. The above features can have the technical effect of using a combination of loss functions to reduce overfitting during training the diffusion transformer model and increase accuracy of the trained diffusion transformer model.

According to this aspect, the variational autoencoder can be configured to receive the training-time multi-view image and, for each of the plurality of views of the training-time multi-view image, generate spatially compressed latent representations of each of the plurality of views of the training-time multi-view image. The above features can have the technical effect increasing computational efficiency of training the diffusion transformer model by performing training in a spatially compressed space.

According to this aspect, the variational autoencoder can be configured to receive the training-time multi-view image and for each of a plurality of subsets of the views of the training-time multi-view image, generate spatio-temporally compressed latent representations of each of the subsets of the views of the multi-view image. The above features can have the technical effect increasing computational efficiency of training the diffusion transformer model by performing training in a temporally compressed space.

According to this aspect, the inference-time output multi-view images can be fed to a 3D model generator that generates a 3D mesh from the inference-time output multi-view images, generating an avatar from the 3D mesh. The above features can have the technical effect of improving the quality of 3D avatars using generation from multi-view images.

According to another aspect of the present disclosure a computerized method is provided, comprising providing a diffusion transformer model that has been trained on a dataset of multi-view images and corresponding text captions. Each multi-view image includes a plurality of views of an object generated from a plurality of camera poses. The diffusion transformer model is configured to receive an inference-time text prompt describing a target object and generate an inference-time output multi-view image including a plurality of views of the target object generated from the plurality of camera poses. The method further includes receiving, via a text encoder of the diffusion transformer model, the inference-time text prompt and encoding the inference-time text prompt as inference-time text embeddings. The method further includes receiving, via a set of one or more diffusion transformer blocks of the diffusion transformer model, an inference-time noisy latent representation and generating an inference-time denoised latent representation. Each of the set of diffusion transformer blocks includes a plurality of adaptive normalization layers conditioned on camera pose and timestep, and at least one dense cross-view attention block configured to compute cross attention on intermediate latent representations and generate cross-view contextualized latent representations. The method further includes receiving, via a decoder of the diffusion transformer model, the inference-time denoised latent representation and generating one or more of the views of the inference-time output multi-view image. The above features can have the technical effect of increasing the speed of computing multi-view images via a diffusion model and improving the visual consistency between generated multi-view images.

According to this aspect, the method can further comprise, for each latent representation: receiving a respective camera pose extrinsic for each inference-time noisy latent representation; embedding, using an encoder, the camera pose extrinsic and a timestep to generate a respective camera pose timestep embedding; and adjusting scale and shift parameters in the adaptive normalization layers with the camera pose timestep embedding, to thereby condition the plurality of adaptive normalization layers on the camera pose extrinsic and the timestep. The above features can have the technical effect of conditioning the generation of multi-view image on camera poses and timesteps.

According to this aspect, the method can further comprise: receiving, via a first multi-layer perceptron network, the camera pose extrinsic and generating a camera pose embedding; receiving, via a second multi-layer perceptron network, the timestep and generating a timestep embedding; and receiving, via a linear layer, a combination of the timestep embedding and the camera pose embedding and generating the camera-pose-timestep embedding. The above features can have the technical effect of combining the camera pose and the timestep embeddings into a single conditioning embedding.

According to this aspect, a multi-head cross attention block of the diffusion transformer blocks can be used to condition the generation of the inference-time denoised latent representation on the inference-time text embeddings. The above features can have the technical effect of providing textual guidance for the generation of the multi-view images.

According to this aspect, the number of views in the inference-time output multi-view images can be in a range between 8 and 64. The above features can have the technical effect of producing multiple views of an object that can be used for generating three dimensional assets.

According to this aspect, the plurality of camera poses can be positioned on even azimuthal distances from each other on a circular orbit. The above features can have the technical effect of producing multiple views of an object that represent a well-balanced group of perspectives on the object.

According to this aspect, the method can further comprise generating a 3D mesh from the inference-time output multi-view images using a 3D model generator and generating an avatar from the 3D mesh. The above features can have the technical effect of improving the quality of 3D avatars using generation from multi-view images.

According to another aspect of the present disclosure, a diffusion transformer model is provided, including a variational autoencoder configured to receive a training-time multi-view image, and generate training-time pre-noise latent representations of the training-time multi-view image. The diffusion transformer model further includes a text encoder configured to receive a training-time text prompt and encode the training-time text prompt as text embeddings. The diffusion transformer model is configured to add noise to the training-time pre-noise latent representations to generate training-time noisy latent representations. The diffusion transformer model is further configured to input the training-time noisy latent representations to a set of one or more diffusion transformer blocks configured to receive training-time noisy latent representations and generate training-time denoised latent representations. Each of the set of diffusion transformer blocks includes a plurality of adaptive normalization layers conditioned on camera pose and timestep, and at least one dense cross-view attention block configured to compute cross attention on intermediate latent representations and generate cross-view contextualized latent representations. The diffusion transformer model is further configured to compute a training loss term between the training-time denoised latent representations and the training-time pre-noise latent representations. The diffusion transformer model is further configured to update parameters in the diffusion transformer model based on the training loss term. The above features can have the technical effect of training a diffusion transformer model for the generation of multi-view images.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing instructions that, when executed, cause the processing circuitry to implement:
a diffusion transformer model that has been trained on a dataset of multi-view images and corresponding text captions, each multi-view image including a plurality of views of an object generated from a plurality of camera poses, the diffusion transformer model being configured to receive an inference-time text prompt describing a target object and generate an inference-time output multi-view image including a plurality of views of the target object generated from the plurality of camera poses, the diffusion transformer model comprising:
a text encoder configured to receive the inference-time text prompt and encode the inference-time text prompt as inference-time text embeddings;
a set of one or more latent diffusion transformer blocks configured to receive an inference-time noisy latent representation and generate an inference-time denoised latent representation, each of the one or more latent diffusion transformer blocks including a plurality of adaptive normalization layers conditioned on camera pose and timestep, and at least one dense cross-view attention block configured to compute cross attention on intermediate latent representations and generate cross-view contextualized latent representations; and
a decoder configured to receive the inference-time denoised latent representation and generate one or more of the views of the inference-time output multi-view image.

2. The computing system of claim 1, wherein the number of views in the output multi-view image generated at inference time by the diffusion transformer model is in a range from 8 to 64.

3. The computing system of claim 1, wherein the plurality of camera poses is positioned on even azimuthal distances from each other on a circular orbit.

4. The computing system of claim 1, wherein a multi-head cross attention block of the one or more diffusion transformer blocks is used to condition the generation of the inference-time denoised latent representation on the inference-time text embeddings.

5. The computing system of claim 1, wherein the processing circuitry is further configured to:
encode an image prompt at a variational autoencoder to generate an image prompt latent representation; and
concatenate the image prompt latent representation with the inference-time noisy latent representation, to thereby condition the generation of the inference-time output multi-view image on the image prompt.

6. The computing system of claim 1, wherein the processing circuitry is further configured to:
receive a respective camera pose extrinsic for each inference-time noisy latent representation,
embed, using an encoder, the camera pose extrinsic and a timestep to generate a respective camera pose timestep embedding; and
adjust scale and shift parameters in the adaptive normalization layers with the camera pose timestep embedding, to thereby condition the plurality of adaptive normalization layers on the camera pose extrinsic and timestep.

7. The computing system of claim 6, wherein, the encoder comprises:
a first multi-layer perceptron network configured to receive the camera pose extrinsic and generate a camera pose embedding;
a multi-layer perceptron network configured to receive the timestep and generate a timestep embedding; and
a linear layer configured to receive a combination of the timestep embedding and camera pose embedding and generate the camera pose timestep embedding.

8. The computing system of claim 1, wherein during training the diffusion transformer model, the processing circuitry is further configured to:
at a variational autoencoder of the diffusion transformer model, generate training-time pre-noise latent representations based on a training-time multi-view image;
encode a training-time text prompt as a training-time text embedding at the text encoder;
receive the training-time pre-noise latent representations, and add noise to the training-time pre-noise latent representations to generate training-time noisy latent representations in a forward diffusion process;
at the set of one or more diffusion transformer blocks, generate training-time denoised latent representations based at least in part on the training-time noisy latent representations;
compute a training loss term between the training-time denoised latent representations and the training-time pre-noise latent representations using a diffusion loss function; and
update parameters in the diffusion transformer model based on the training loss term.

9. The computing system of claim 8, wherein the training loss term is a combination of a mean square error term and a variational bound term.

10. The computing system of claim 8, wherein the variational autoencoder is configured to receive the training-time multi-view image and for each of the plurality of views of the training-time multi-view image generate spatially compressed latent representations of each of the plurality of views of the training-time multi-view image.

11. The computing system of claim 8, wherein the variational autoencoder is configured to receive the training-time multi-view image and for each of a plurality of subsets of the views of the training-time multi-view image, generate spatio-temporally compressed latent representations of each of the subsets of the views of the multi-view image.

12. The computing system of claim 1, wherein the inference-time output multi-view images are fed to a 3D model generator that generates a 3D mesh from the inference-time output multi-view images, generating an avatar from the 3D mesh.

13. A computerized method, comprising:
providing a diffusion transformer model that has been trained on a dataset of multi-view images and corresponding text captions, each multi-view image including a plurality of views of an object generated from a plurality of camera poses, the diffusion transformer model being configured to receive an inference-time text prompt describing a target object and generate an inference-time output multi-view image including a plurality of views of the target object generated from the plurality of camera poses;
receiving, via a text encoder of the diffusion transformer model, the inference-time text prompt and encoding the inference-time text prompt as inference-time text embeddings;
receiving, via a set of one or more diffusion transformer blocks of the diffusion transformer model, an inference-time noisy latent representation and generating an inference-time denoised latent representation, each of the set of diffusion transformer blocks including a plurality of adaptive normalization layers conditioned on camera pose and timestep, and at least one dense cross-view attention block configured to compute cross attention on intermediate latent representations and generate cross-view contextualized latent representations; and
receiving, via a decoder of the diffusion transformer model, the inference-time denoised latent representation and generating one or more of the views of the inference-time output multi-view image.

14. The method of claim 13, wherein the method further comprises, for each latent representation,
receiving a respective camera pose extrinsic for each inference-time noisy latent representation,
embedding, using an encoder, the camera pose extrinsic and a timestep to generate a respective camera pose timestep embedding; and
adjusting scale and shift parameters in the adaptive normalization layers with the camera pose timestep embedding, to thereby condition the plurality of adaptive normalization layers on the camera pose extrinsic and the timestep.

15. The method of claim 14, wherein the method further comprises:
receiving, via a first multi-layer perceptron network, the camera pose extrinsic and generating a camera pose embedding;
receiving, via a second multi-layer perceptron network, the timestep and generating a timestep embedding; and
receiving, via a linear layer, a combination of the timestep embedding and the camera pose embedding and generating the camera-pose-timestep embedding.

16. The method of claim 13, wherein a multi-head cross attention block of the diffusion transformer blocks is used to condition the generation of the inference-time denoised latent representation on the inference-time text embeddings.

17. The method of claim 13, wherein the number of views in the inference-time output multi-view images is in a range between 8 and 64.

18. The method of claim 13, wherein the plurality of camera poses is positioned on even azimuthal distances from each other on a circular orbit.

19. The method of claim 13, further comprising:
generating a 3D mesh from the inference-time output multi-view images using a 3D model generator; and
generating an avatar from the 3D mesh.

20. A computing system, comprising:
processing circuitry and memory storing instructions that, when executed, cause the processing circuitry to implement:
a diffusion transformer model, including:
a variational autoencoder configured to receive a training-time multi-view image, and generate training-time pre-noise latent representations of the training-time multi-view image; and
a text encoder configured to receive a training-time text prompt and encode the training-time text prompt as text embeddings;
wherein the diffusion transformer model is configured to:
add noise to the training-time pre-noise latent representations to generate training-time noisy latent representations;
input the training-time noisy latent representations to a set of one or more diffusion transformer blocks configured to receive training-time noisy latent representations and generate training-time denoised latent representations, each of the set of diffusion transformer blocks including a plurality of adaptive normalization layers conditioned on camera pose and timestep, and at least one dense cross-view attention block configured to compute cross attention on intermediate latent representations and generate cross-view contextualized latent representations;
compute a training loss term between the training-time denoised latent representations and the training-time pre-noise latent representations; and
update parameters in the diffusion transformer model based on the training loss term.
